(19) United States
(12) Patent Application Publication
(10) Pub. No.: US 2024/0067542 A1
(43) Pub. Date: Feb. 29, 2024

(54) BIOCIDE TREATMENT OF PRODUCED WATER

(71) Applicant: Avonlea Technology Holdings Corp., Calgary (CA)

(72) Inventors: Ronald Otto Lincz, Calgary (CA); Douglas James Brett, Foothills (CA)

(73) Assignee: Avonlea Technology Holdings Corp., Calgary (CA)

(21) Appl. No.: 18/312,425

(22) Filed: May 4, 2023

Related U.S. Application Data
(60) Provisional application No. 63/373,240, filed on Aug. 23, 2022.

(30) Foreign Application Priority Data
Feb. 15, 2023 (CA) 3190331

(51) Int. Cl. C02F 1/50; A01N 37/34; A01N 59/00

(52) U.S. Cl. CPC C02F 1/50; A01N 37/34; A01N 59/00; C02F 2209/36; C02F 2301/063; C02F 2303/04

(57) ABSTRACT

An example of an apparatus and method of operating the apparatus to treat produced water. The apparatus includes a cavitation chamber. In addition, the apparatus includes an inlet to receive produced water with a microorganism. The apparatus further includes a pump to pump the produced water from the inlet into the cavitation chamber at a predetermined pressure. The apparatus also includes an injector to inject a biocide to the produced water to control a population of the microorganism. Furthermore, the apparatus includes a micro-bubble generator disposed within the cavitation chamber. The micro-bubble generator reduces a pressure of the produced water below a fluid vapor pressure to create micro-bubbles which collapse to generate a micro shockwave to enhance the efficacy of the biocide at reducing the population of the microorganism. The apparatus further includes an outlet to release the produced water after the population of the microorganism is lowered.

### CROSS-REFERENCE TO RELATED APPLICATIONS

This application claims priority to U.S. Application No. 63/373,240, filed Aug. 23, 2022, which also claims priority to Canadian Application No. 3,190,331, filed Feb. 15, 2023, both of which are herein incorporated by reference in their entireties.

### BACKGROUND

Oilfield produced water is often reinjected into the source formation through off-set injection wells, as a secondary oil recovery method called a water flood, which increases oil recovery and maintains formation pressure within the producing zone. In some cases, a polymer is added to the produced water in a process called a polymer flood prior to reinjection, which increases the produced water viscosity and further improves oil recovery. Produced water contains a variety of anaerobic microbial species capable of causing a wide range of damage to a reservoir and production system if allowed to reproduce and thrive unchecked. Risks associated with produced water microbes or microorganisms include the generation of hydrogen sulfide by reducing sulfur in the formation. The hydrogen sulfide may convert a sweet well (i.e. a well that produces substantially no hydrogen sulfide) to a sour well (i.e. a well that produces a substantial amount of hydrogen sulfide). Furthermore, hydrogen sulfide is a colorless gas that is toxic to humans and animals and may cause harm or death around the well. In addition, microbes may cause corrosion to metal through a multitude of microbial related mechanisms, such as iron reduction or oxidation. Risks associated with microbial growth in produced water associated with polymer floods may be elevated as the polymer is readily consumed by microbes to drive and accelerate their growth.

Current biocide treatment programs effectively reduce microbial populations by attacking dispersed, free floating microbes that can be easily contacted with a biocide chemical. A significant population of microbes exist as biomass or bio-clumps which are often not immediately affected by the biocide treatment. These biomasses may form a protective polysaccharide film around them which is difficult for the biocide chemical to penetrate. Accordingly, the inner microbes may be protected from the biocide chemicals. As a result, these biomasses may be reinjected or reintroduced into the producing formation to add to the workload of the biocide treatment. In addition, biomasses may continue to grow and eventually plug the producing formation and stick to the inner workings of the production facility, causing corrosion damage, flow restrictions, and other related problems.

### BRIEF DESCRIPTION OF THE DRAWINGS

Reference will now be made, by way of example only, to the accompanying drawings in which:

FIG. 1 is a schematic representation of the components of an example of an apparatus to control a microbe population in produced water;

FIG. 2 is a schematic representation of the components of another example of an apparatus to control a microbe population in produced water;

FIG. 3 is a flowchart of an example process of controlling a microbe population in produced water;

FIG. 4 is a graph showing the effectiveness of different methods of controlling a microbe population in produced water;

FIG. 5A is a schematic drawing of a sample of produced water with bio-clumps protected by a polysaccharide film;

FIG. 5B is a schematic drawing of a sample of produced water undergoing hydrodynamic cavitation to break down the polysaccharide film to disperse the bio-clumps; and

FIG. 5C is a schematic drawing of a sample of produced water with dispersed microbes treated with a biocide.

### DETAILED DESCRIPTION

Produced water, such as water from an oilfield well that is often mixed with oil, contains an amount of anaerobic microbial species capable of causing a wide range of damage to the well and production system if allowed to reproduce and thrive unchecked. For example, microbes may generate hydrogen sulfide that can convert a sweet well to a sour well. Hydrogen sulfide is a colorless gas that is toxic to humans and animals and may cause harm or death around the well. In addition, the microbes may cause corrosion to metal through a multitude of microbial related mechanisms. Risks associated with microbial growth in produced water associated with polymer floods may be elevated as the polymer is readily consumed by microbes to drive and accelerate their growth.

An apparatus and method are provided to control a microbial population in the produced water with hydrodynamic cavitation, in conjunction with biocide treatment, at a level of intensity that increases microbial kill, in comparison to biocide treatment alone. Using hydrodynamic cavitation in this manner may enhance microbial kill by breaking down biomass or bio-clumps to disperse and increase the surface area exposure of individual microbes to a biocide chemical. In addition, hydrodynamic cavitation enhances microbial kill by dispersing both the biocide chemical and microbes throughout the produced water media to increase surface area contact with each. Furthermore, hydrodynamic cavitation may enhance microbial kill by causing microbial cell disruption to weaken the microbes and making them more susceptible to biocide treatment.

Hydrodynamic cavitation is the process where a fluid experiences a pressure drop as it flows through a cavitation chamber. The pressure drop creates micro-bubbles in the fluid as a rapid decrease of localized pressure in the fluid below the fluid vapor pressure creates localized micro-bubbles. As the fluid returns to a pressure above the fluid vapor pressure, the micro-bubbles collapse to release a high amount of localized energy in the form of elevated pressures and temperatures within a very short period. The fluid system also experiences a very high fluid shear to generate a micro shockwave which in turn increases surface area contact between the constituents of the fluid. This hydrodynamic cavitation reaction in a controlled environment may be used to enhance chemical and physical reactions partially due to the energy and heat release, the subsequent micro shockwaves being generated, as well as the release of free radicals which have been generated through the process.

In the present examples of biocide treatment, additionally treating produced water with hydrodynamic cavitation may also cause cell disruption to the microbes. The disruption may increase the vulnerability of microbes to the biocide treatment to further improve the overall kill performance of the treatment.

Accordingly, utilizing hydrodynamic cavitation in combination with a biocide treatment provides a substantially complete kill of microbes to reduce the likelihood of microbes present in the produced water after treatment. The produced water may then be reinjected into the producing zone to reduce the likelihood of issues associated with uncontrolled microbial growth. Furthermore, the hydrodynamic cavitation treatment allows the biocide chemical to increase its kill performance on microbes in-situ to the formation due to the reduced population of microbes being reinjected into the formation. As the improved kill performance cycles through the producing formation, the microbial population within the recycled produced water will decrease allowing for an eventual reduction in the biocide chemical dosing rate and cost savings to the operator.

It is to be understood by a person of skill that a single microbial life cycle may take minutes or hours to occur and that populations may double with every generation.

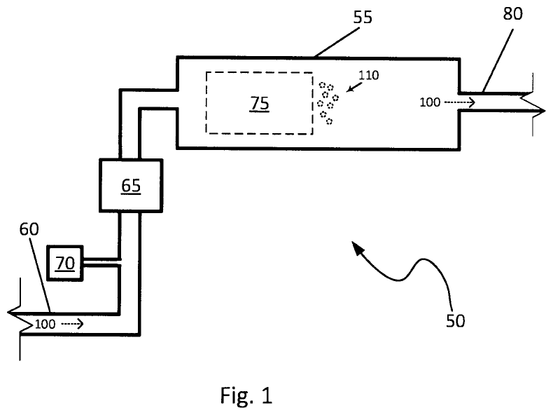

Referring to FIG. 1, a schematic representation of an apparatus 50 to control a microbe population in produced water 100 is generally shown. The apparatus 50 may include additional components, such as various additional control valves, filters, or processing devices. For example, the apparatus 50 may include flow controllers, additional pumps, or other mechanical features to assist with the flow of the produced water 100 through the apparatus 50. In other examples, the apparatus 50 may further include heaters or additional injectors to add further biocides or other chemicals into the processed water flow to further enhance the efficacy of killing the microorganisms. The microorganisms to be controlled is not particularly limited and may include various forms of bacteria or other living organisms present in the produced water that may generate undesirable contaminants, such as hydrogen sulfide, or cause corrosion by reducing or oxidizing metals in the system. In the present example, the apparatus 50 includes a cavitation chamber 55, an inlet 60 at which the produced water 100 is received, a pump 65, an injector 70, a micro-bubble generator 75, and an outlet 80.

In the present example, the cavitation chamber 55 is not particularly limited. In particular, the size of the cavitation chamber 55 is not limited and any size suitable for an application with predetermined target flow rates may be used. It is to be appreciated by a person of skill with the benefit of this description that the cavitation chamber 55 is also not limited to any design. In the present example, the cavitation chamber 55 has a capacity of approximately 0.5 L to 1.0 L. In other examples, the cavitation chamber 55 may be significantly larger for applications involving the processing of larger volumes of produced water 100, such as from multiple sources, where the flow at the inlet 60 is greater. Alternatively, additional cavitation chambers may be added to operate in parallel with each other to increase the flow capacity. In other examples where the apparatus 50 is to be used for smaller batches of produced water 100 at a processing facility, the cavitation chamber 55 may be smaller.

The construction of the cavitation chamber 55, such as the walls, is not particularly limited and may use a wide variety of materials. In the present example, the cavitation chamber 55 is a steel chamber. The cavitation chamber 55 may be lined internally with an anti-corrosion layer and include an insulating layer. In other examples, the cavitation chamber 55 may be constructed from other materials that have the appropriate mechanical properties to withstand the operating conditions of the apparatus 50, such as corrosion, temperatures, and pressures. Suitable materials may include plastic or other metals and metal alloys, such as stainless steel. Furthermore, it is to be appreciated by a person of skill with the benefit of this description that in some examples, the cavitation chamber 55 may be a single unitary body constructed from the same material, such as from a molding process. The cavitation chamber 55 may be manufactured from several pieces bolted or welded together.

The inlet 60 is to receive the produced water 100 from a source. In the present example, the inlet 60 may be a connector to an external pumping station that pumps a produced water 100 from a reservoir collecting produced water after the separation of oil from the oilfield well or directly from an oilfield well into the apparatus 50. The produced water 100 received at the inlet 60 is not particularly limited and may include dissolved minerals in an aqueous solution. In addition, the produced water 100 includes a microorganism, such as a native microorganism from the formation. In some examples, the produced water 100 may be mixed with other components that are not soluble with water to form a suspension of different components, such as an emulsion or particulate matter. Accordingly, the suspension received at the inlet 60 may be subjected to pre-processing steps, such as filtration or separation via centrifuge or gravity, to extract the aqueous component.

The pump 65 is to pump the produced water 100 from the inlet 60 to the cavitation chamber 55. In the present example, the pump 65 is to maintain the flow of the produced water 100 at a predetermined pressure that can generate micro-bubbles 110 after passing through the micro-bubble generator 75. The pump 65 is not particularly limited and may be any type of pump capable of pumping produced water 100 from the inlet 60 to the cavitation chamber 55 and maintaining the predetermined pressure. In the present example, the pump 65 is a variable frequency drive pump. In other examples, the pump 65 may be a rotary pump, or any other style of pump capable of pumping consistent volumes at a stable pressure. It is to be appreciated by a person of skill with the benefit of this description that the pump 65 may be modified or omitted if the produced water 100 is to be received at the inlet 60 at a pressure that is substantially the same as or greater than the predetermined pressure. In some examples, the pump 65 may also be used to draw in the produced water 100 at the inlet 60, such as from a storage reservoir.

In the present example, a controller (not shown) may be used to control the operation of the pump 65. In particular, the controller may be a processor connected to sensors at various locations along a produced water flow path, such as a pressure sensor near the cavitation chamber 55. The sensors may provide data to the controller, which in turn can send control signals to control the pump 65 to adjust or maintain the pressure of produced water 100 entering the cavitation chamber 55. In particular, the controller may control the operation of the pump 65 to maintain a substantially constant target pressure at or about the predetermined pressure. The control signals are not limited and may be different depending on the pump 65. In the present example, the pump 65 is a variable frequency drive pump. Accordingly, the controller may send commands to control the pump speed depending on the pressure measured by a sensor. The pump speed may be increased or decreased to adjust or maintain the pressure of the produced water 100. Accordingly, the pump 65 and controller may operate together to maintain a fluid pressure at the predetermined target pressure. The predetermined target pressure is not particularly limited and may vary from one application to another depending on the components in the produced water 100, which may affect the chemical and physical characteristics of the produced water 100, such as the fluid vapor pressure.

It is to be appreciated by a person of skill in the art with the benefit of this description that the cavitation chamber 55 and the micro-bubble generator 75 are designed to operate within a range of parameters, such as within a range of target pressures of the fluid being introduced into the cavitation chamber 55. By maintaining the pressure and flow rate of the produced water 100 at about the target values or close to the target values, the efficiency of the micro-bubble generator 75 is greater than if the pressure is higher or lower than the target pressure. In other examples, instead of using a processor as the controller, a mechanical or analog replacement of the processor may be used. For example, a mechanical pressure gauge may be used to measure the pressure of the produced water 100 on either side of the pump 65 to trigger a mechanical switch to control the pump speed when threshold values are reached.

In examples where the pressure of the produced water 100 at the inlet 60 is greater than the predetermined target pressure of the produced water 100 into the cavitation chamber 55, the pump 65 may be replaced with a pressure regulator to reduce the pressure of the produced water 100 as it enters the cavitation chamber 55. In further examples, the apparatus 50 may include both a pump 65 and a pressure regulator to accommodate input pressures that may be over or under the target pressure of the produced water 100 into the cavitation chamber 55. Accordingly, by controlling the pressure of produced water 100 as it enters the cavitation chamber 55, the apparatus 50 may be used in a wide variety of applications that may have varying input pressures.

The injector 70 is disposed on the line carrying the produced water 100 from the inlet 60 to the cavitation chamber 55. It is to be appreciated by a person of skill with the benefit of this description that the position of the injector is not particularly limited and may be placed at multiple locations on the line prior to the flow of produced water 100 entering the cavitation chamber 55. For example, the injector 70 may be disposed prior to or after the pump 65. In the present example, the injector 70 is to inject a biocide into the flow of the produced water 100. In particular, the biocide is a substance that is toxic to a microorganism to control the population of the microorganism. The biocide is not particularly limited and may be selected from a plurality of chemicals and other substances to target the microorganism. In some examples, the biocide may be a broad spectrum biocide designed to kill a wide variety of microorganisms.

In the present example, the biocide injected by the injector 70 into the produced water flow may be a biocide formed from a polyethylene glycol excipient. The active ingredient of the biocide may be a chemical that operates as a broad spectrum biocide that becomes unstable in an aqueous solution, such as 2,2-dibromo-3-nitrilopropionamide. Since the active ingredient in the present example is unstable, it may operate to kill microorganisms and then degrade into non-active components to be safely released into the environment or reinjected into a formation without harming the environment. In addition, the biocide may also include other components, such as sodium bromide, to be used as part of the mechanism by which the biocide operates. In the specific example and experiments discussed below, the biocide used may be AQUCAR DB20 microbicide from DUPONT. In other examples, cocodiamine and glutaraldehyde may be used as biocides to control microorganisms in produced water.

The micro-bubble generator 75 is disposed within the cavitation chamber 55. The micro-bubble generator 75 creates micro-bubbles 110 by reducing the pressure in localized regions of the produced water 100 as it passes through the micro-bubble generator 75. The pressure in the localized regions is to be reduced to below the vapor pressure of the produced water 100. The manner by which the micro-bubble generator 75 reduces localized pressure in regions is not particularly limited. For example, the micro-bubble generator 75 may be a hydrodynamic cavitation reactor having a blade moving at a high speed through the produced water 100 to create localized regions of low pressure as the blade passes through.

Once the micro-bubbles 110 form and leave the localized regions of low pressure, the micro-bubbles 110 collapse as they return to the higher pressure regions of the produced water 100. Upon collapsing, the micro-bubbles 110 release localized energy, which may generate a micro shockwave in the produced water 100. The micro shockwave enhances the efficacy of the biocide injected into the produced water 100 to further reduce the population of a microorganism in the produced water 100. The manner by which the micro shockwave enhances the efficacy of the biocide is not particularly limited. For example, the micro shockwave may mechanically disrupt the population of the microorganisms, such as by further mixing the biocide throughout the population of microorganisms such that there are no areas of lower concentration. Furthermore, for populations of microorganisms that form a polysaccharide film around a bio-clump of microorganisms, the polysaccharide film is blocks biocide access to the microorganisms. The micro shockwave may also break down the polysaccharide film to expose microorganisms protected behind the polysaccharide film to the biocide.

In further examples, free radicals may be generated from the disassociation of vapor trapped within the imploding micro-bubble. Free radicals contain unpaired orbital electrons making them highly reactive to enhance chemical reaction rates. The high reactivity of free radicals absorbed by the microorganisms may lead to the damage of cell components causing death of the microorganism.

The outlet 80 is to release the produced water after the treatment to lower the population of the microorganism with the use of biocide and hydrodynamic cavitation. In the present example, the outlet 80 may be a connector to an external pumping station that pumps a produced water 100 to a storage reservoir or reinjects the produced water 100 back into the formation either through a producing oilfield well or another borehole into the formation for the purpose of reinjecting produced water 100.

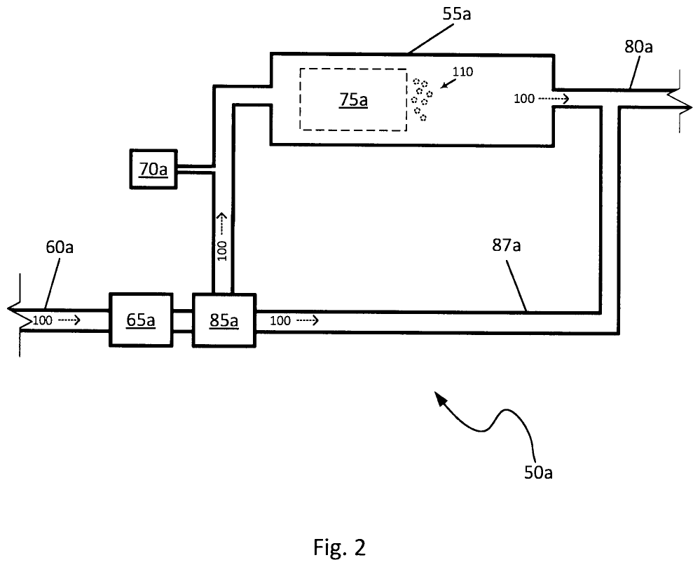

Referring to FIG. 2, another example an apparatus 50a to control a microbe population in produced water 100 is generally shown. Like components of the apparatus 50a bear like reference to their counterparts in the apparatus 50, except followed by the suffix “a”. The apparatus 50a includes a cavitation chamber 55a, an inlet 60a at which the produced water 100 is received, a pump 65a, an injector 70a, a micro-bubble generator 75a, an outlet 80a, and an analyzer 85a.

In the present example, the cavitation chamber 55a, the pump 65a, the injector 70a, and the micro-bubble generator 75a may be substantially similar or identical to the counterparts in the apparatus 50. In particular, the cavitation chamber 55a is to receive produced water 100 via the inlet 60a. The produced water 100 is pumped into the cavitation chamber 55a with the pump 65a. Along the path from the inlet 60a to the cavitation chamber 55a, an injector 70a is to inject a biocide into the flow of the produced water 100. Micro-bubbles 110 are generated with the micro-bubble generator 75a and the subsequent collapse of the micro-bubbles generates a micro shockwave that enhances the efficacy of the biocide injected into the produced water 100 to further reduce the population of a microorganism in the produced water 100.

The analyzer 85a is disposed proximate to the inlet 60a and receives the flow of the produced water 100 for analysis. In the present example, the analyzer 85a is to determine the size of the population of the microorganism in the produced water 100. The size of the population of the microorganism provides information about the potential operational risks of the produced water 100 in terms of potential damage to the pumping equipment or the formation if the produced water 100 is reinjected into the formation. In the present example, the analyzer 85a may include a valve to direct the produced water 100 into the cavitation chamber 55a when the population of microorganisms is above a predetermined threshold. If the analyzer 85a determines that the population of microorganisms is below the predetermined threshold, the produced water 100 may be redirected through the bypass 87a to the outlet 80a.

The manner by which the analyzer 85a determines the size of the population of the microorganism in the produced water 100 is not particularly limited. In the present example, the analyzer 85a performs a DNA screening test to detect different types of microorganisms. In some examples, the produced water test may involve extracting samples for culture growth. In other examples, in line methods, such as spectroscopic techniques, may be used. It is to be appreciated by a person of skill with the benefit of this description that where the population of different types of microorganisms can be distinguished, different thresholds can be set for different microorganisms based on individual risk assessments.

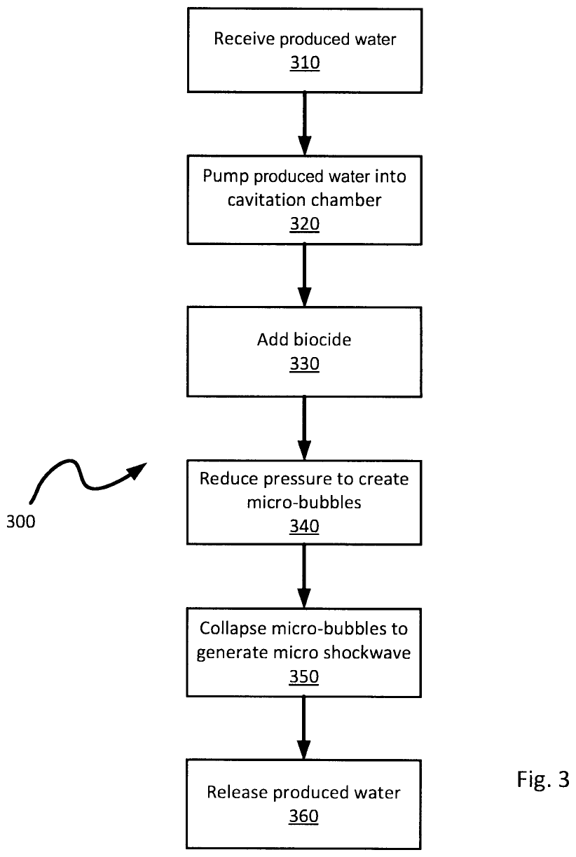

Referring to FIG. 3, a flowchart of an example method of controlling a microbe population in produced water 100 is generally shown at 300. In order to assist in the explanation of method 300, it will be assumed that method 300 may be performed by the apparatus 50. Indeed, the method 300 may be one way in which the apparatus 50 may operate.

Beginning at block 310, produced water 100 containing a microorganism is to be received at the inlet 60. The manner by which produced water 100 is received is not particularly limited and may involve being pumped a source, such as an oilfield well, or received from a reservoir collecting produced water after separation of oil from the oilfield well. The produced water 100 is then pumped into the cavitation chamber 55 at block 320. In the present example, the pressure at which the produced water 100 enters the cavitation chamber 55 is to be maintained at a substantially constant target pressure. The predetermined target pressure is not particularly limited and may be selected to increase the performance of the micro-bubble generator 75. Since the dimensions of the system are generally fixed, the pressure may be controlled by measuring and controlling the flow rate of produced water 100 into the cavitation chamber 55.

Block 330 involves adding biocide to the flow of the produced water 100 between the inlet 60 and the cavitation chamber 55. The biocide is to be used in the cavitation chamber 55 to control the population of a microorganism.

Next, block 340 comprises reducing the pressure in localized regions of the produced water 100 as it passes through the micro-bubble generator 75 to a pressure that is below the value of the vapor pressure of the produced water 100. By reducing the pressure below the vapor pressure, micro-bubbles 110 are created in the produced water 100. The manner by which the micro-bubble generator 75 reduces localized pressure in regions is not particularly limited. In the present example, the micro-bubble generator 75 is a hydrodynamic cavitation reactor having a blade moving at a high speed through the produced water 100 to create localized regions of low pressure as the blade passes through.

Block 350 comprises collapsing the micro-bubbles 110 as they move away from the region of localized low pressure and return the normal pressure of the produced water 100. Upon collapsing, the micro-bubbles 110 generate a micro shockwave that enhances the efficacy of the biocide at reducing the population of the microorganism in the produced water 100.

The manner by which the micro shockwave enhances the efficacy of the biocide is not particularly limited. For example, the micro shockwave may mechanically disrupt the population of the microorganisms, such as by further mixing the biocide throughout the population of microorganisms such that there are no areas of lower concentration. Furthermore, for populations of microorganisms that form a non-permeable polysaccharide film around a bio-clump of microorganisms reduces access of the biocide to the microorganisms. The micro shockwave may also break down the polysaccharide film to expose microorganisms protected behind the polysaccharide film to the biocide. In further examples, free radicals may be generated from the disassociation of vapor trapped within the imploding micro-bubble. Free radicals contain unpaired orbital electrons making them highly reactive to enhance chemical reaction rates. The high reactivity of free radicals absorbed by the microorganisms may lead to the damage of cell components causing death of the microorganism. For example, hydroxyl radicals may combine to generate hydrogen peroxide which is also highly oxidative. The oxidative nature of hydrogen peroxide may provide an additional mechanism for microbial destruction through oxidation.

Next, the treated produced water with the lowered microorganism population is released via the outlet 80 at block 360. In the present example, the produced water 100 released via the outlet 80 is to be reinjected into the formation. In other examples, the produced water may be stored in a reservoir or discarded safely into the environment.

It is to be understood that variations of the method 300 are contemplated. For example, the method may involve preprocessing steps, such as carrying out an analysis of the produced water 100 received at the inlet 60, to determine a size of the population of the microorganism. Based on the size of the population, the produced water 100 may be directed to a bypass directly to the outlet 80 if the population of microorganisms is below an acceptable threshold limit such that the produced water 100 is not treated.

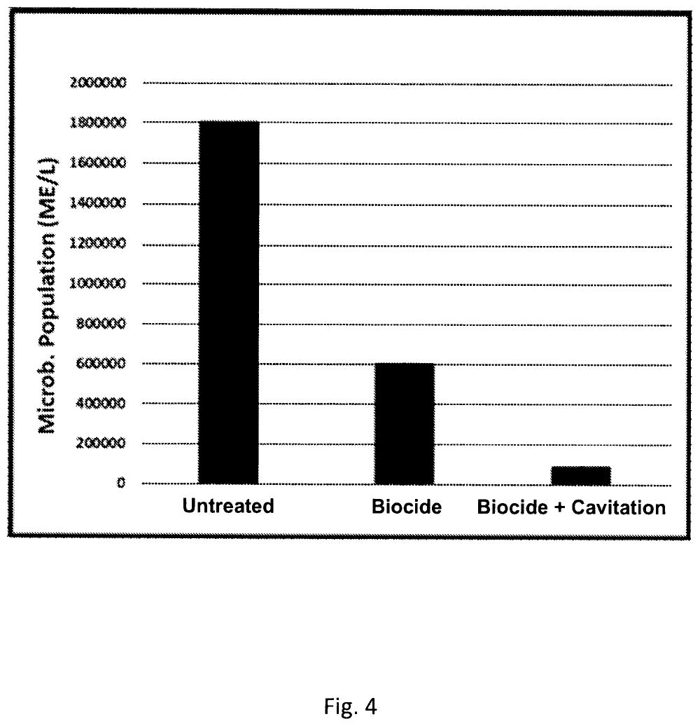

Referring to FIG. 4, field data from biocide treatment of a sample of produced water from a single source is shown. In particular, the data was collected from a sample point at the outlet 80 of the apparatus. The apparatus was operating at a temperature range between about 5° C. and about 15° C. The collected samples were analyzed approximately 24 hours after collection to determine the microbial equivalent per liter (ME/L). The analysis was carried out using an ATP test that measures the active and living microbial load in a sample.

In the untreated sample, the injector 70 was not operating and the micro-bubble generator 75 was deactivated. The microbial population was found to be about 1.8×10⁶ ME/L. In the sample with a conventional biocide treatment only, the injector 70 injected AQUCAR DB20 microbiocide from DUPONT at a concentration of about 200 mg/L of produced water while the micro-bubble generator 75 remained deactivated. This sample provided a microbial population of about 0.6×10⁶ ME/L, or 33% of the untreated sample. In the sample subjected to both biocide and cavitation, the microbial population was found to be reduced to about 80,000 ME/L. Accordingly, a person of skill in the art with the benefit of this description will understand that a conventional biocide treatment may allow for a microbial population to be re-established over 1 to 2 generational growth cycles after the treatment based on the reduction in size of the microbial population. In contrast, using cavitation in combination with a biocide treatment, the microbial population may re-establish after 4 to 5 generational growth cycles to re-establish the original microbial population. Therefore, combining cavitation with the biocide may result in the reduced use of biocide as it takes longer for the microbial population to re-establish.

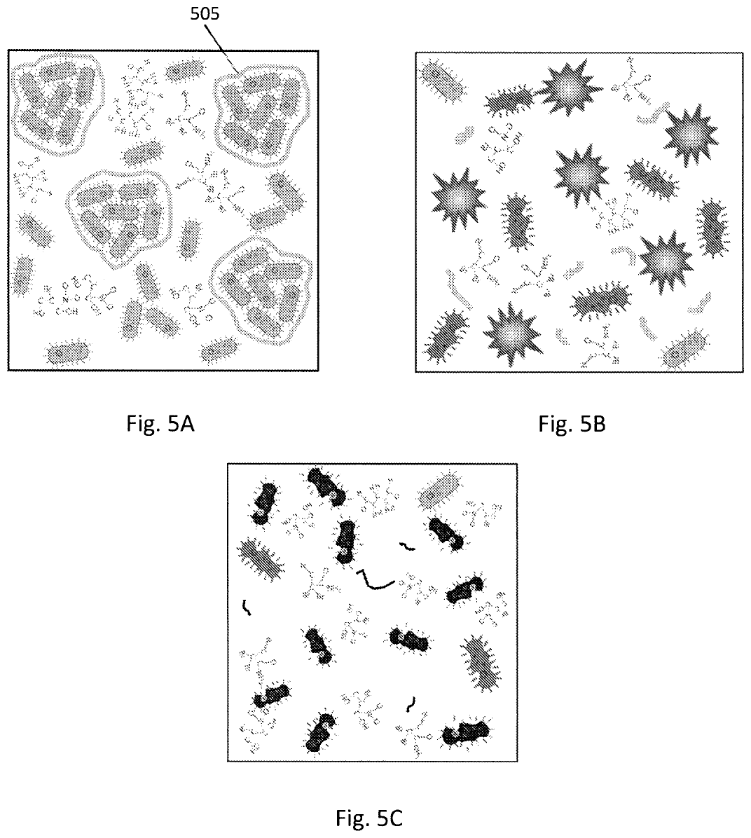

Referring to FIGS. 5A, 5B, and 5C, a schematic representation is shown to illustrate the treatment of produced water with biocide and cavitation. Referring to FIG. 5A, an untreated sample of produced water is shown with microorganisms present. In this example, some microbes are surrounded by a polysaccharide film 505. The micro shockwaves break down microbial biomasses by breaking the polysaccharide film 505, which disperses microbes throughout the fluid system as shown in FIG. 5B. This disperses the biocide and increases the contact area between the biocide chemical and microbes through high fluid shear. The biocide may then inflict microbial cell disruption as their vulnerability to biocide treatment increases as shown in FIG. 5C.

It should be recognized that features and aspects of the various examples provided above may be combined into further examples that also fall within the scope of the present disclosure.

What is claimed is:

1. A method of treating produced water to reduce microbe concentration, the method comprising:
receiving the produced water, wherein the produced water includes a microorganism;
pumping the produced water into a cavitation chamber;
adding a biocide to the produced water, wherein the biocide is to control a population of the microorganism;
reducing a pressure of the produced water in the cavitation chamber as the produced water moves away from an inlet, wherein the pressure is reduced to below a fluid vapor pressure of the produced water to create micro-bubbles;
collapsing the micro-bubbles to generate a micro shockwave, wherein the micro shockwave enhances an efficacy of the biocide at reducing the population of the microorganism; and
releasing the produced water after the population of the microorganism is lowered.

2. The method of claim 1, wherein the micro shockwave mechanically disrupts the population of microorganisms.

3. The method of claim 2, wherein the micro shockwave breaks down a polysaccharide film protecting the microorganism from the biocide.

4. The method of claim 1, wherein collapsing the micro-bubbles generates free radicals to damage cell components of the microorganism.

5. The method of claim 1, wherein the microorganism is a bacteria.

6. The method of claim 1, wherein the biocide includes polyethylene glycol as an excipient.

7. The method of claim 6, wherein the biocide includes sodium bromide.

8. The method of claim 7, wherein the biocide includes 2-2dibromo-3-nitrilopropionamide.

9. The method of claim 1, further comprising analyzing the produced water to determine a size of the population of the microorganism.

10. The method of claim 9, wherein analyzing the produced water comprises performing a DNA screening test.

11. The method of claim 10, further comprising reinjecting the produced water into a formation.

12. An apparatus comprising:
a cavitation chamber;
an inlet to receive produced water, wherein the produced water includes a microorganism;
a pump to pump the produced water from the inlet into the cavitation chamber at a predetermined pressure;
an injector to inject a biocide to the produced water, wherein the biocide is to control a population of the microorganism;
a micro-bubble generator disposed within the cavitation chamber to create micro-bubbles, wherein the micro-bubble generator reduces a pressure of the produced water below a fluid vapor pressure, and wherein the micro-bubbles collapse to generate a micro shockwave, wherein the micro shockwave enhances an efficacy of the biocide at reducing the population of the microorganism; and
an outlet to release the produced water after the population of the microorganism is lowered.

13. The apparatus of claim 12, wherein the micro shockwave mechanically disrupts the population of microorganisms.

14. The apparatus of claim 13, wherein the micro shockwave breaks down a polysaccharide film protecting the microorganism from the biocide.

15. The apparatus of claim 12, wherein the micro-bubble generator generates free radicals to damage cell components of the microorganism.

16. The apparatus of claim 12, wherein the microorganism is a bacteria.

17. The apparatus of claim 12, wherein the injector is to inject polyethylene glycol as an excipient of the biocide.

18. The apparatus of claim 12, further comprising an analyzer to determine a size of the population of the microorganism in the produced water.

19. The apparatus of claim 18, wherein the analyzer performs a DNA screening test.

20. The apparatus of claim 19, wherein the outlet is to reinject the produced water into a formation.
